(19) United States
(12) Patent Application Publication
(10) Pub. No.: US 2005/0232351 A1
(43) Pub. Date: Oct. 20, 2005

(54) Apparatus and method for changing image quality in real time in a digital camcorder

(76) Inventor: Kyung-Hun Jung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/085,600

(22) Filed: Mar. 22, 2005

(30) Foreign Application Priority Data
Mar. 23, 2004 (KR) 2004-19712

(51) Int. Cl. H04N 7/12

(52) U.S. Cl. 375/240.03; 375/240.01

(57) ABSTRACT

Apparatus and method are provided for changing an image quality storage in real time. In the apparatus and method, an effect signal receiving unit receives an image mode change request signal from a user while photographing an image. A mode change recognizing unit determines an image mode in response to an output signal of the effect signal receiving unit, and generates an image quality adjust command according to the determination result. A control unit generates a mode control signal for changing an image mode of a moving image in response to the image quality adjust command output from the mode change recognizing unit. An image compressor compresses an input image according to the mode control signal output from the control unit.

### PRIORITY

This application claims the benefit under 35 U.S.C. § 119(a) of an application entitled “Apparatus and Method for Changing Image Quality in Real Time in a Digital Camcorder” filed in the Korean Intellectual Property Office on Mar. 23, 2004 and assigned Serial No. 2004-19712, the entire contents of which are incorporated herein by reference.

### BACKGROUND OF THE INVENTION

1. Field of the Invention

The present invention relates generally to a digital camcorder for storing an input moving image in a digital storage medium or a mobile phone with a moving image photographing function. In particular, the present invention relates to an apparatus and method for changing an image quality of a moving image photographed by a user and storing the moving image by using a compression scheme corresponding to the changed image quality in a a digital storage medium, such as a digital camcorder or a mobile phone with a camera (also known as a camera phone).

2. Description of the Related Art

In general, a digital camcorder refers to a device for photographing a visible still image or moving image and storing the photographed image in a digital storage medium included therein. Formats of the image data stored in the digital camcorder are roughly classified into a graphic file format such as Bit Mapped Graphics (BMP), Graphics Interchange Format (GIF) and Joint Picture Experts Group (JPEG), for storing still images (or pictures), and a moving image file format such as Moving Picture Experts Group (MPEG), Audio Video Interleave (AVI) and QuickTime™ Movie Clip (MOV), for storing moving images.

While the conventional analog camcorder records images in analog format, the digital camcorder segments an image into bitmap images and records the luminance of each bitmap image in digital format. Thus, the digital camcorder has high compatibility with a personal computer in terms of image data, facilitating image editing. Compared with the conventional analog camcorder, the digital camcorder is easier to carry, can store photographed image in its internal memory device such as a hard disk and a memory card, and can be connected to an external computer to transmit the photographed image thereto.

However, a conventional digital camcorder records picture or moving image data in a limited memory space. Therefore, if there is no available memory, a user of the camcorder has to delete the data stored therein manually to provide available space in order to store additional images.

FIG. 1 is a block diagram schematically illustrating a structure of a general digital camcorder. Referring to FIG. 1, an image photographed by a user is digitalized by an encoder 102 and stored in a frame buffer 103. An image compressor 104 compresses frames stored in the frame buffer 103 depending on set values such as the number of frames per second (FPS) and a quantization step, previously designated by a mode input unit 101, and stores the compressed frames in a memory 105.

An available-photographing time calculator 106 calculates an available (or empty) memory space of the memory 105, i.e., an available photographing time, by checking the amount of photographed image stored in the memory 105. Herein, the available photographing time is calculated by dividing an available memory space of the memory 105 by a storage rate at which a compressed image is stored in the memory 105. The calculated available photographing time is displayed for the user through a display 107 such as a view finder.

In the conventional digital camcorder, the user selects a desired image quality through the mode input unit 101 before photographing. Once the user starts photographing, the user cannot change the image quality while photographing. If the user desires to change the image quality, the user must stop the ongoing photographing and set a desired new image quality.

Herein, the image quality refers to frames per second (FPS), quantization step, and image size. In still/moving image compression schemes such as JPEG/MPEG, the quantization step refers to a parameter related to the image quality. A decrease in the parameter value provides a high image quality but requires a larger memory storage space. However, an increase in the parameter value decreases an image quality but requires less memory storage space.

In addition, an increase in the FPS, which indicates a high-quality moving image, requires a larger memory space. A decrease in the FPS, which indicates a low-quality moving image, requires a less memory space. It is generally assumed that a larger-sized image has a higher quality than that of a smaller-sized image, and thus requires more storage space.

As described above, in the conventional digital camcorder, the user cannot change the values indicating the image quality while photographing. Therefore, once photographing begins, the user cannot change the image quality or a storage rate of the memory unless the user stops photographing. In some cases, therefore, the user may photograph a less-important image at the image quality set for a highly-important image, making inefficient use of the limited memory.

A description will now be made of an operation of the conventional digital camcorder. In photographing a moving image using the digital camcorder, if a user desires to photograph the image with a preset value, the user performs photographing without mode changing, or presets image quality-related information such as the quantization step and the size of a desired image, through a mode setting key, before photographing the image.

The subsequent photographing is achieved in the set mode, and the image input to the digital camcorder is compressed with a compression scheme corresponding to the set mode and stored in a memory. In this case, a less-important image may be stored with the compression scheme for a highly-important image, resulting in efficient use of the memory. In order to prevent inefficient use of the memory, the user should inconveniently stop the ongoing photographing and set a desired new mode, which can result in the interruption of the photographing of a moving image. In order to prevent this inconvenience, the user should purchase a separate internal or external memory, which, however, increases the purchasing cost.

Although the recent trend is that a multimedia function of a mobile communication apparatus such as a mobile phone with a moving image photographing function (also known as a camcorder phone) is increasingly emphasized, a reduction in price of a flash memory for storing the multimedia information is lower than expected.

Hence, there is a demand for an alternative plan to allow a user to freely adjust a moving image compression method of a digital camcorder having a limited memory, while photographing. In other words, there is a demand for an alternative means to dynamically adjust an image quality by considering a desired photographing time and/or a desired image quality, thereby enabling a user to record a moving image at a desired quality for a desired time.

### SUMMARY OF THE INVENTION

It is, therefore, an object of the present invention to provide a moving image photographing apparatus for enabling a user to dynamically adjust an image quality by considering a required photographing time and/or a desired image quality while photographing a moving image using a digital camcorder, and a method for changing the image quality in real time.

It is another object of the present invention to provide a moving image photographing apparatus for dynamically adjusting a quality of a moving image and recording the moving image at a desired quality for a desired time via a compression scheme, and a method for changing the image quality in real time.

It is further another object of the present invention to provide a moving image photographing apparatus for dynamically adjusting a compression scheme of a moving image being photographed by a photographing apparatus such as a digital camcorder to allow a user to change an image quality while photographing, to thereby maximize image-storing capacity, and a method for changing the image quality in real time.

It is still another object of the present invention to provide a moving image photographing apparatus for changing an image quality in real time to adjust image-storing capacity thereby maximizing efficiency of a memory in which a compressed image is stored, and a method for changing the image quality in real time.

In accordance with one aspect of the present invention, there is provided a moving image photographing apparatus for storing an input moving image. The apparatus includes an effect signal receiving unit for receiving an image mode change request signal from a user while photographing images; a mode change recognizing unit for determining an image mode in response to an output signal of the effect signal receiving unit, and generating an image quality adjust command according to the determination result; a control unit for generating a mode control signal for changing an image mode of a moving image in response to the image quality adjust command output from the mode change recognizing unit; and an image compressor for compressing an input image according to the mode control signal output from the control unit.

In accordance with anther aspect of the present invention, there is provided a method for changing an image quality in a moving image photographing apparatus for storing an input moving image, the method including receiving an image mode change request signal from a user while photographing images; determining an image mode in response to the image mode change request signal, and generating a control signal according to the determination result; and if the control signal is a signal for adjusting the number of frames per second (FPS), performing a FPS adjusting routine to dynamically change an image mode; and storing an input image in a memory using the changed image mode and calculating an available photographing time.

Preferably, the FPS adjusting routine comprises comparing a current FPS with an input FPS corresponding to the control signal; maintaining the current FPS if the current FPS is equal to the input FPS, and changing a current image mode to an image mode corresponding to the input FPS if the current FPS is not equal to the input FPS; and upon occurrence of an interrupt signal, compressing an input image according to the input FPS.

Preferably, if the control signal is a signal for adjusting a quantization step, the method includes performing a quantization step adjusting routine to dynamically change the image mode.

Preferably, the quantization step adjusting routine includes comparing a current quantization step with an input quantization step corresponding to the control signal; maintaining the current quantization step if the current quantization step is equal to the input quantization step, and changing a current image mode to an image mode corresponding to the input quantization step if the current quantization step is not equal to the input quantization step; and upon occurrence of an interrupt signal, compressing an input image according to the input quantization step.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram schematically illustrating a structure of a conventional digital camcorder;

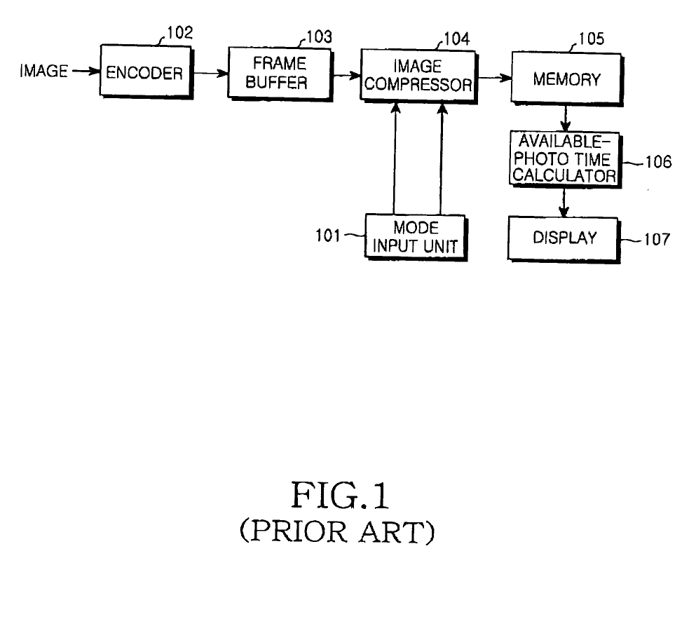

FIG. 2 is a block diagram schematically illustrating a structure of a digital camcorder according to an embodiment of the present invention;

FIG. 3 is a diagram illustrating an example of an image displayed on a display of a digital camcorder according to an embodiment of the present invention;

FIG. 4 is a flowchart illustrating a process of changing an image quality in real time in a digital camcorder according to an embodiment of the present invention;

FIG. 5 is a flowchart illustrating a frames per second (FPS) adjusting routine of FIG. 4 according to an embodiment of the present invention; and

FIG. 6 is a flowchart illustrating the quantization step adjusting routine of FIG. 4 according to an embodiment of the present invention.

Throughout the drawings, the same element is designated by the same reference numeral or character.

### DETAILED DESCRIPTION OF AN EXEMPLARY EMBODIMENT

An embodiment of the present invention will now be described in detail with reference to the accompanying drawings. In the following description, a detailed description of known functions and configurations incorporated herein has been omitted for conciseness.

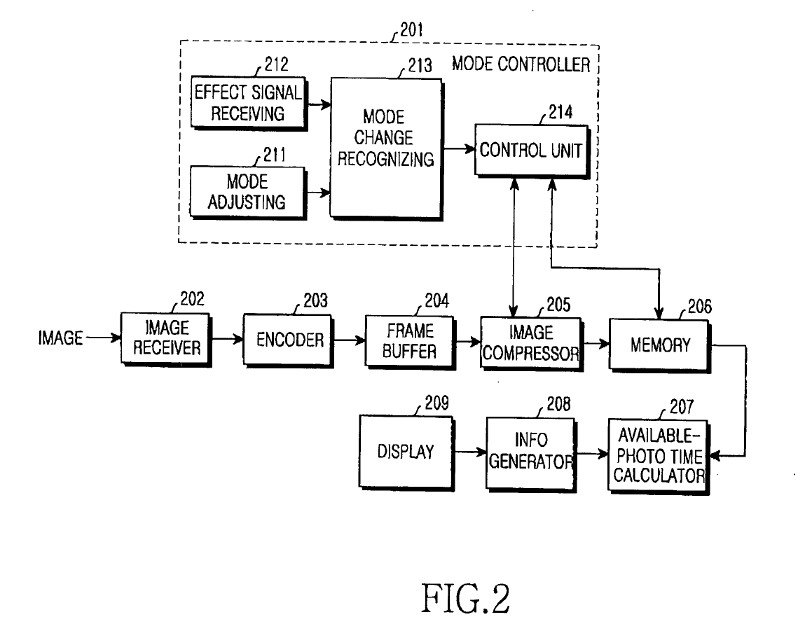

FIG. 2 is a block diagram schematically illustrating a structure of a digital camcorder according to an embodiment of the present invention. As illustrated, an internal structure of a digital camcorder according to an embodiment of the present invention includes a mode controller 201, an image receiver 202, an encoder 203, a frame buffer 204, an image compressor 205, a memory 206, an available-photographing time calculator 207, an information generator 208, and a display 209.

The mode controller 201 includes a mode adjusting unit 211, an effect signal receiving unit 212, a mode change recognizing unit 213, and a control unit 214. The mode adjusting unit 211 provides mode change means such as a menu for changing the number of frames per second (FPS) and a quantization step. The effect signal receiving unit 212 detects a predetermined effect signal generated to change a mode of an image being photographed. The mode change recognizing unit 213 detects signals output from the mode adjusting unit 211 and the effect signal receiving unit 212, and analyzes the detected signals. The control unit 214 receives the signal provided from the mode change recognizing unit 213, and controls mode changing in association with the image compressor 205 and the memory 206, depending on the received signal.

The image receiver 202 receives an image photographed by a user, and outputs an image signal. The encoder 203 converts the image signal received from the image receiver 202 into a digital image signal. The frame buffer 204 temporarily stores the image signal provided from the encoder 203.

The image compressor 205 compresses the image signal temporarily stored in the frame buffer 204 through a predetermined compression processing method. The memory 206 stores the image signal compressed by the image compressor 205.

The available-photographing time calculator 207 determines a residual capacity of the memory 206 by checking a storage rate at which the compressed image signal is stored in the memory 206, and calculates an available photographing time using the determination result. For example, the available-photographing time calculator 207 calculates the available photographing time by dividing an available (or empty) memory space of the memory 206 by the storage rate at which the compressed image signal is stored in the memory 206.

The information generator 208 acquires quantization step information, FPS information, and image size information from the mode controller 201, acquires available photographing time information calculated by the available-photographing time calculator 207, and outputs a data signal. The display 209 displays the photographed input image in real time, and also displays information on the data signal output from the information generator 208.

A description will now be made of an operation of the digital camcorder according to an embodiment of the present invention.

The image receiver 202 is arranged in a predetermined part of the digital camcorder, and receives an image signal provided from a camcorder lens (not shown) for photographing an object. The encoder 203 converts the image signal provided from the image receiver 202 into a digital image signal, and the digital image signal is stored in the frame buffer 204.

The image compressor 205 compresses the digitalized image frames stored in the frame buffer 204 according to the FPS and the quantization step previously set in the controller 201, and the compressed frames are stored in the memory 206.

The mode controller 201 performs a predetermined control operation on the input image signal. Generally, a change button (not shown) for changing a mode of an input image according to a user's control operation is mounted on a predetermined part of the digital camcorder. If a predetermined effect signal for changing a mode of the currently photographed image is generated by the change button, the effect signal receiving unit 212 receives the effect signal. The effect signal received at the effect signal receiving unit 212 is analyzed by the mode change recognizing unit 213. The mode adjusting unit 211 is manipulated by the user to change an image mode using a menu.

Herein, means for changing a quality mode of the image includes hot keys associated with the change button for mode changing, and the mode adjusting unit 211 for menu-based mode changing. Although the embodiment of the present invention supports both of the two mode changing methods, it is also possible to support only one of the two methods.

The mode change recognizing unit 213 analyzes the effect signal, and delivers the analyzed effect signal to the control unit 214. Then the control unit 214 generates a mode control signal for changing a previously set image mode to a new image mode corresponding to the received effect signal in association with the image compressor 205 and the memory 206.

The image compressor 205 adaptively compresses the image frames provided from the frame buffer 204 according to the mode control signal and stores the compressed image frames in the memory 206. The available-photographing time calculator 207 calculates the available photographing time by dividing an available memory space of the memory 206 by the storage rate at which the compressed image signal is stored in the memory 206, and provides the calculated available photographing time information to the display 209 in association with the information generator 208. Then the display 209 displays data signals for user's visual recognition based on the input image information and the calculated available photographing time information.

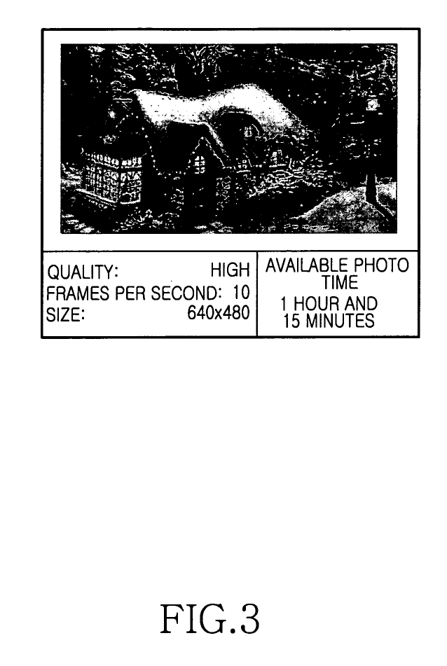

FIG. 3 is a diagram illustrating an example of an image displayed on the display of the digital camcorder according to an embodiment of the present invention. Referring to FIG. 3, the display displays a small version of the currently photographed image, an image quality determined by applying a quantization step to the photographed image, FPS of the photographed image, an image size (e.g., 1024×768, 800×600, and 640×480), and an available photographing time indicating a residual recording time, by way of example. The embodiment of the present invention should not be restricted to the foregoing details.

In order to prevent the user from being confused based on a wrong stereotype that the higher value indicates higher quality, the display displays, for example, High, Medium, and Normal instead of displaying the quantization step value. However, the embodiment of the present invention should not be limited to this example. In this case, the lower quantization step value indicates the higher quality.

With reference to FIGS. 2 and 3, a description will now be made of a process of dynamically adjusting an image quality in a digital camcorder according to an embodiment of the present invention.

The embodiment of the present invention provides a digital camcorder that allows a user to change a FPS value and a quantization step value while photographing an image. The user checks information on the residual recording time and the current image quality from the display, and increases/decreases the FPS value and/or the quantization step value as occasion demands. A change in either value affects the residual recording time, and the user can re-adjust the image quality by checking the displayed residual recording time.

For example, assuming that the residual recording time is short and the user has no spare magnetic tape or flash memory, if the quantization step value is increased or the FPS value is decreased by the user, the residual recording time is increased. However, assuming that a required recording time is not long and a high-quality image is needed, if the quantization step value is decreased and the FPS value is increased, the residual recording time is reduced but the higher-quality image can be acquired. This adjustment can be repeated according to the contents of the image and the available memory space, during photographing.

Although the FPS value and the quantization step value can be adjusted independently in the embodiment of the present invention, it is also possible to adjust the FPS value and the quantization step value in a complementary manner in order not to change the residual recording time.

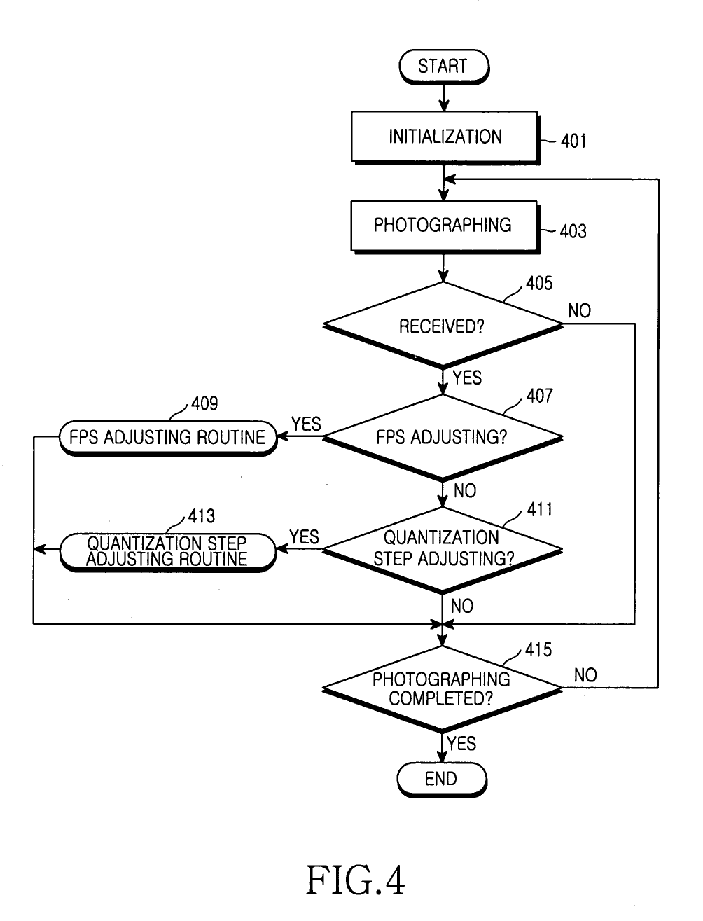

FIG. 4 is a flowchart illustrating a process of changing an image quality in real time in a digital camcorder according to an embodiment of the present invention. Referring to FIG. 4, upon receiving a driving signal for photographing from a user, the control unit 214 receives in step 401 an initialization signal which is received together with the driving signal, and initializes an image mode (FPS and quantization step) previously set in the memory 206 depending on the initialization signal. In step 403, as an image is being photographed by the user, the control unit 214 continuously monitors whether an interrupt signals is received.

The control unit 214 determines in step 405 whether an interrupt signal or an effect signal for mode changing is received from the mode adjusting unit 211 or the effect signal receiving unit 212. If the signal is received, the control unit 214 determines in step 407 whether the received signal is a signal for FPS adjusting. If the received signal is not the signal for FPS adjusting, the control unit 214 determines in step 411 whether the received signal is a signal for quantization step adjusting.

However, if it is determined in step 407 that the received signal is the signal for FPS adjusting, the control unit 214 proceeds to step 409 where it performs FPS adjusting routine so as to dynamically change an image quality while photographing an image. If it is determined in step 411 that the received signal is the signal for quantization step adjusting, the control unit 214 proceeds to step 413 where it performs a quantization step adjusting routine so as to dynamically change an image quality while in photographing.

Henceforth, the user photographs an image at the changed new image quality setting. The control unit 214 determines in step 415 whether the image photographing is completed. If the image photographing is not completed, the control unit 214 returns to step 403. However, if the image photographing is completed, the control unit 214 ends the process.

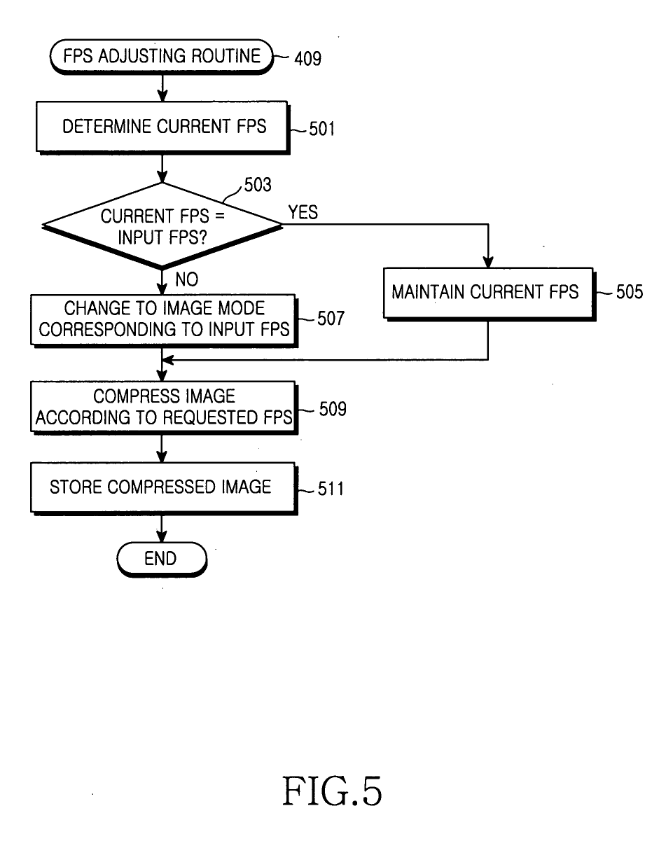

FIG. 5 is a flowchart illustrating the FPS adjusting routine 409 of FIG. 4. Referring to FIG. 5, upon receiving an FPS adjust command from the mode change recognizing unit 213, the control unit 214 determines a current FPS in step 501, and compares the current FPS with a FPS newly input by the user in step 503. If the current FPS is equal to the input FPS, the control unit 214 proceeds to step 505 where it maintains the current FPS. However, if the current FPS is not equal to the input FPS, the control unit 214 proceeds to step 507 where it changes its image mode to a new image mode corresponding to the input FPS. After a lapse of a predetermined time, the control unit 214 controls the image compressor 205 to compress an input image according to the changed new image mode in step 509. In step 511, the control unit 214 stores the compressed image in the memory 206.

The available-photographing time calculator 207 calculates an available photographing time by checking an available memory space of the memory 206, and provides the calculated available photographing time information to the user through the display 209.

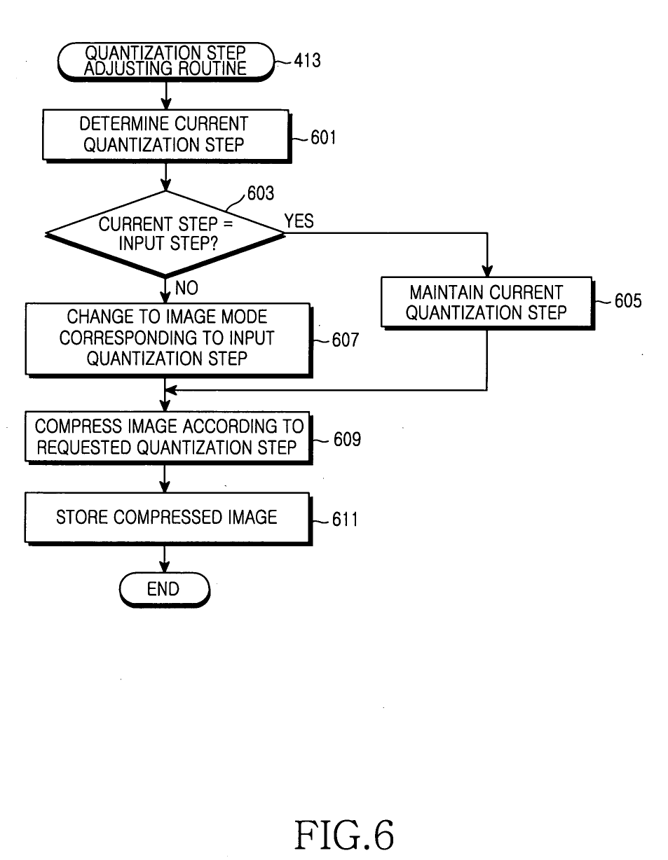

FIG. 6 is a flowchart illustrating the quantization step adjusting routine 413 of FIG. 4. Referring to FIG. 6, upon receiving a quantization step adjust command from the mode change recognizing unit 213, the control unit 214 determines a current quantization step in step 601, and compares the current quantization step with a quantization step newly input by the user in step 603. If the current quantization step is equal to the input quantization step, the control unit 214 proceeds to step 605 where it maintains the current quantization step. However, if the current quantization step is not equal to the input quantization step, the control unit 214 proceeds to step 607 where it changes its image mode to a new image mode corresponding to the input quantization step. After a lapse of a predetermined time, the control unit 214 controls the image compressor 205 to compress an input image according to the changed new image mode in step 609. In step 611, the control unit 214 stores the compressed image in the memory 206.

The available-photographing time calculator 207 calculates an available photographing time by checking an available memory space of the memory 206, and provides the calculated available photographing time information to the user through the display 209.

As can be understood from the foregoing description, a novel apparatus and method for changing an image quality enables a user to dynamically adjust an image quality by considering a required photographing time and/or a desired image quality while photographing a moving image using a digital camcorder. Therefore, the user can record a moving image at a desired quality for a desired time.

In addition, the proposed apparatus and method dynamically adjusts a compression scheme to achieve a change in photographing time and image quality, thereby maximizing the utilization of a limited memory.

While the invention has been shown and described with reference to a certain embodiment thereof, it will be understood by those skilled in the art that various changes in form and details may be made therein without departing from the spirit and scope of the invention as defined by the appended claims.

1. A moving image photographing apparatus for storing an input moving image, the apparatus comprising:
an effect signal receiving unit for receiving an image mode change request signal from a user while photographing an image;
a mode change recognizing unit for determining an image mode in response to an output signal of the effect signal receiving unit, and generating an image quality adjust command according to the determination result;
a control unit for generating a mode control signal for changing an image mode of a moving image in response to the image quality adjust command output from the mode change recognizing unit; and
an image compressor for compressing an input image according to the mode control signal output from the control unit.

2. The moving image photographing apparatus of claim 1, wherein the image mode change request signal is generated by selecting a change button for image mode changing.

3. The moving image photographing apparatus of claim 1, wherein the image mode change request signal is generated by selecting a predetermined element included in a menu.

4. The moving image photographing apparatus of claim 1, wherein the image mode is changed depending on the number of frames per second (FPS) or a quantization step.

5. A method for changing an image quality in a moving image photographing apparatus for storing an input moving image, the method comprising the steps of:
receiving an image mode change request signal from a user while photographing an image;
determining an image mode in response to the image mode change request signal, and generating a control signal according to the determination result; and
if the control signal is a signal for adjusting the number of frames per second (FPS), performing an FPS adjusting routine to dynamically change an image mode; and
storing an input image in a memory using the changed image mode and calculating an available photographing time.

6. The method of claim 5, wherein the image mode change request signal is generated by selecting a change button for image mode changing.

7. The method of claim 5, wherein the image mode change request signal is generated by selecting a predetermined element included in a menu.

8. The method of claim 5, wherein the FPS adjusting routine comprises the steps of:
comparing a current FPS with an input FPS corresponding to the control signal;
maintaining the current FPS if the current FPS is equal to the input FPS, and changing a current image mode to an image mode corresponding to the input FPS if the current FPS is not equal to the input FPS; and
upon occurrence of an interrupt signal, compressing an input image according to the input FPS.

9. The method of claim 5, further comprising the step of, if the control signal is a signal for adjusting a quantization step, performing a quantization step adjusting routine to dynamically change the image mode.

10. The method of claim 9, wherein the quantization step adjusting routine comprises the steps of:
comparing a current quantization step with an input quantization step corresponding to the control signal;
maintaining the current quantization step if the current quantization step is equal to the input quantization step, and changing a current image mode to an image mode corresponding to the input quantization step if the current quantization step is not equal to the input quantization step; and
upon occurrence of an interrupt signal, compressing an input image according to the input quantization step.

11. The method of claim 5, further comprising the step of providing the calculated available photographing time to the user through a display.

12. A method for changing an image quality in a moving image photographing apparatus for storing an input moving image, the method comprising the steps of:
detecting a request for a change in image quality storage while recording an image;
determining available time to record by dividing the available memory by the amount of time it takes to store images in memory;
adjusting at least one of the number of frames per second (FPS), for performing an FPS adjusting routine to dynamically change an image mode and a quantization step for changing quantization levels; and
storing an input image using the adjusted FPS and adjusted quantization step.

13. The method of claim 12, wherein the image quality levels comprise high, medium and normal.

14. The method of claim 12, wherein the image photographing apparatus comprises a camcorder.

15. The method of claim 12, wherein the image photographing apparatus comprises a mobile phone with an image recording function.

16. The method of claim 15, further comprising:
requesting an image quality change via a dedicated key on the mobile terminal.

17. The method of claim 15, further comprising:
requesting an image quality change via a menu screen on the mobile terminal.

18. The method of claim 12, wherein the FPS adjusting step comprises the steps of:
comparing a current FPS with an input FPS;
maintaining the current FPS if the current FPS is equal to the input FPS, and changing a current image mode to an image mode corresponding to the input FPS if the current FPS is not equal to the input FPS; and
upon occurrence of an interrupt signal, compressing an input image according to the input FPS.

19. The method of claim 12, wherein the quantization adjusting step comprises the steps of:
comparing a current quantization step with an input quantization step;
maintaining the current quantization step if the current quantization step is equal to the input quantization step, and changing a current image mode to an image mode corresponding to the input quantization step if the current quantization step is not equal to the input quantization step; and
upon occurrence of an interrupt signal, compressing an input image according to the input quantization step.

20. The method of claim 12, further comprising the step of providing the determined available time to a user through a display
